(19) United States
(12) Patent Application Publication
(10) Pub. No.: US 2026/0111157 A1
(43) Pub. Date: Apr. 23, 2026

(54) STORAGE MEDIUM STORING PROGRAM CAPABLE OF QUICKLY INSTALLING PRINTER DRIVER, CONTROL METHOD, AND INFORMATION PROCESSING APPARATUS

(71) Applicant: CANON KABUSHIKI KAISHA, Tokyo (JP)

(72) Inventor: HIDEHARU SAWADA, Chiba (JP)

(21) Appl. No.: 19/350,420

(22) Filed: Oct. 6, 2025

(30) Foreign Application Priority Data
Oct. 22, 2024 (JP) 2024-185922

(51) Int. Cl. G06F 3/12

(52) U.S. Cl. CPC G06F 3/1225; G06F 3/1204; G06F 3/1285

(57) ABSTRACT

A non-transitory computer-readable storage medium storing a program for installing a printer driver that has been installed in a first information processing apparatus and has certificate data attached thereto, which certifies validity of a digital signature, into a second information processing apparatus communicably connected to the first information processing apparatus. Whether or not the printer driver which has been installed is set to be sharable with the second information processing apparatus is determined. In a case where it is determined that the printer driver is set to be sharable with the second information processing apparatus, a screen related to changing of setting of whether or not to perform notification concerning reliability of the printer driver when installing the printer driver into the second information processing apparatus is displayed.

### BACKGROUND

### Field of the Technology

The present disclosure relates to a storage medium storing a program that is capable of quickly installing a printer driver, a control method, and an information processing apparatus.

### Description of the Related Art

A representative print control program that controls a printer is, for example, a printer driver of Windows (registered trademark). A driver set of the printer driver of Windows includes a catalog file (CAT file). To the catalog file, a digital signature can be attached to prevent tampering of the driver (see Japanese Laid-Open Patent Publication (Kokai) No. 2014-48956).

The digital signature is data generated by encrypting a hash value of a driver (file), to which the signature is to be attached, with a secret key, and is capable of certifying that the driver has not been tampered. Further, a certificate is attached to the digital signature. By decrypting the secret key with a public key in this certificate, it is possible to extract the hash value. Then, by comparing this hash value and a hash value of the actual catalog file, it is possible to certify validity of the catalog file, i.e. verify that the contents of each file in the driver set have not been altered.

Further, there is a case where a printer driver is installed in an information processing apparatus, such as a personal computer (PC). In this case, depending on an issuer of a digital signature attached to a catalog file, a confirmation screen for confirming whether or not to perform the installation is sometimes displayed. This confirmation screen is similarly displayed in a print server system in which, for example, a host PC connected to a printer is set as a print server, and a print instruction is given from a client PC to the printer via the print server. For example, in Point & Print (registered trademark) of Microsoft Corporation, a print server transfers a printer driver already installed in this print server to a client PC. Then, the client PC can install the printer driver transferred from the print server.

As described above, in the print server system, the confirmation screen is sometimes displayed when a driver is installed into the client PC. For example, when a driver is installed in the print server, even if installation of this driver is permitted on the confirmation screen, the confirmation screen is sometimes displayed again when the driver is installed into the client PC. Therefore, a user is required to perform the operation of permitting installation of the driver on the confirmation screen every time, and the permission operation (confirmation operation) is troublesome. That is, although the driver has already been installed in the print server and the user obviously intends to install the same driver as this driver into the client PC, the confirmation screen is redundantly displayed again.

### SUMMARY

The present disclosure is directed to providing a mechanism that makes it possible to quickly install a printer driver.

In a first aspect of the present disclosure, there is provided a non-transitory computer-readable storage medium storing a program for installing a printer driver having already been installed in a first information processing apparatus and having certificate data attached thereto for certifying validity of a digital signature, into a second information processing apparatus communicably connected to the first information processing apparatus, wherein the program causes a computer of the first information processing apparatus to execute a sharing determination step for determining whether or not the printer driver having already been installed is set to be sharable with the second information processing apparatus, and a display step for displaying, in a case where it is determined in the sharing determination step that the printer driver is set to be sharable with the second information processing apparatus, a screen related to changing of setting of whether or not to perform notification concerning reliability of the printer driver when installing the printer driver into the second information processing apparatus.

In a second aspect of the present disclosure, there is provided a control method of performing control to install a printer driver having already been installed in a first information processing apparatus and having certificate data attached thereto for certifying validity of a digital signature, into a second information processing apparatus communicably connected to the first information processing apparatus, including determining whether or not the printer driver which has been installed is set to be sharable with the second information processing apparatus, and displaying, in a case where it is determined that the printer driver is set to be sharable with the second information processing apparatus, a screen related to changing of setting of whether or not to perform notification concerning reliability of the printer driver when installing the printer driver into the second information processing apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic diagram showing an entire configuration of a printing system according to a first embodiment.

FIG. 2 is a block diagram showing a hardware configuration of a server PC.

FIG. 3 is a block diagram showing software configurations of the server PC and a client PC.

FIG. 4 is a sequence diagram showing a process (installation process) executed between the server PC and the client PC.

FIG. 5 is a diagram showing a configuration of an installation set of a printer driver.

FIGS. 6A to 6C are diagrams each showing a screen displayed in the printing system.

FIGS. 7A and 7B are diagrams useful in explaining transition of screens displayed on a display section of the server PC.

FIG. 8 is a diagram showing a screen displayed on the display section of the server PC.

FIG. 9 is a flowchart of a process performed by an installer.

FIG. 10 is a diagram showing a screen displayed on the display section of the server PC, according to a second embodiment.

FIG. 11 is a flowchart of a process performed by the installer.

FIG. 12 is a block diagram showing software configurations of the server PC, the client PC, and a domain server PC, according to a third embodiment.

FIG. 13 is a diagram showing a screen displayed on the display section of the server PC.

FIG. 14 is a flowchart of a process performed by the installer.

### DESCRIPTION OF THE EMBODIMENTS

The present disclosure will now be described in detail below with reference to the accompanying drawings showing embodiments thereof. Configurations described in the following embodiments are given only by way of example, and are by no means intended to limit the scope of the present disclosure. For example, components of each configuration of the present disclosure can be replaced with desired components which can exhibit the same functions. Further, desired components can be added. Further, two or more desired components (features) of the embodiments can be combined.

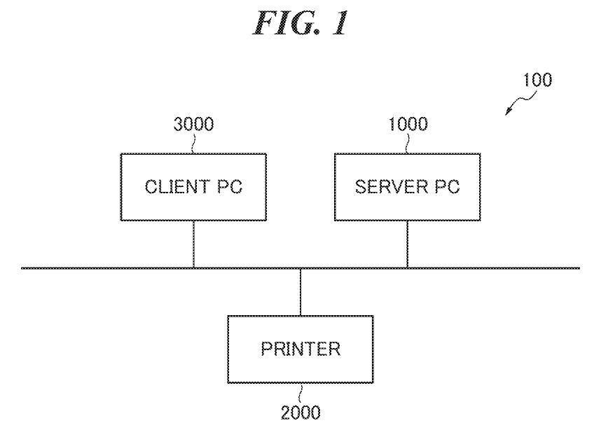

A first embodiment will be described below with reference to FIGS. 1 to 9. FIG. 1 is a schematic diagram showing an entire configuration of a printing system 100 according to the first embodiment. As shown in FIG. 1, the printing system100 includes a server PC (first information processing apparatus) 1000, a printer 2000, and a client PC (second information processing apparatus) 3000, and these are communicably connected to each other. Note that the connection method is not particularly limited, but, for example, can be wired connection or wireless connection. A print instruction to the printer 2000 is sometimes given from the server PC 1000 to the printer 2000 (hereinafter sometimes referred to as the “first case”). Alternatively, a print instruction is sometimes given from the client PC 3000 to the printer 2000 via the server PC 1000 (hereinafter sometimes referred to as the “second case”). In both of the first and second cases, a printer driver for controlling the printer 2000 is required to have been installed in the server PC 1000. Further, in the second case, the same printer driver as the printer driver already installed in the server PC 1000 is also required to have been installed in the client PC 3000. This is because print data generated by an application of the client PC 3000 is required to be mediated by the printer driver on the server PC 1000 before being input to the printer 2000. Note that the application is not particularly limited, but a document generation application or a spreadsheet application, for example, can be used. Further, to cause the printer driver of the server PC 1000 to mediate the print data, it is necessary to cause the same printer driver to mediate the print data output from the application on the client PC 3000.

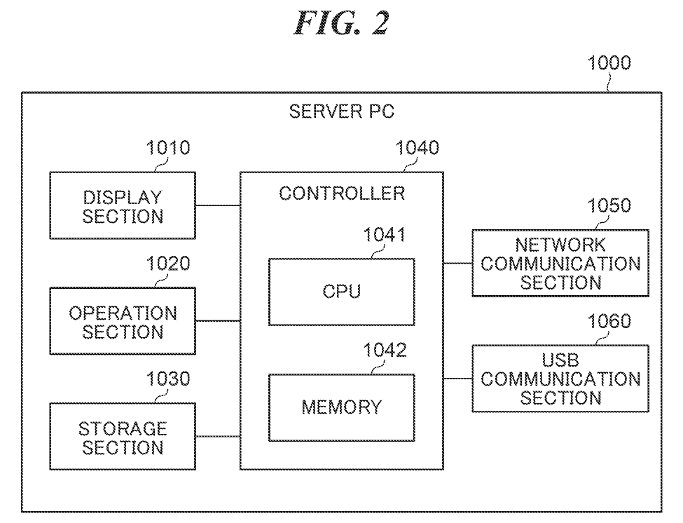

FIG. 2 is a block diagram showing a hardware configuration of the server PC 1000. Note that the hardware configuration of the client PC 3000 is the same as the hardware configuration of the server PC 1000. As shown in FIG. 2, the server PC1000 includes a display section 1010, an operation section 1020, a storage section 1030, a controller 1040, a network communication section 1050, and a universal serial bus (USB) communication section 1060. The controller 1040 is a computer that includes a central processing unit (CPU) 1041 and a memory 1042, and controls the overall operation of the server PC 1000. The display section 1010 is formed e.g. by a liquid crystal display and displays a variety of information. The operation section 1020 includes, for example, a mouse, a keyboard, and a touch panel, and receives an instruction or the like from a user using the printing system 100. The storage section 1030 has a storage medium, such as a hard disk and a solid state drive (SSD), and stores a variety of software programs necessary for the operation of the server PC 1000. Further, an operating system (OS) 1110A, a printer driver, and so forth, described hereinafter are also stored in the storage section 1030. The network communication section 1050 is connected to a network and enables communication between the same and external apparatuses, such as the printer 2000 and the client PC 3000. The USB communication section 1060 enables communication between the same and the above-mentioned external apparatuses by USB connection. The server PC 1000 and the printer 2000 are connected via the network communication section 1050 or the USB connection section 1060. Note that the software processing in the present embodiment is realized by the CPU 1041 executing the software stored in the storage section 1030 and loaded into the memory 1042 of the controller 1040.

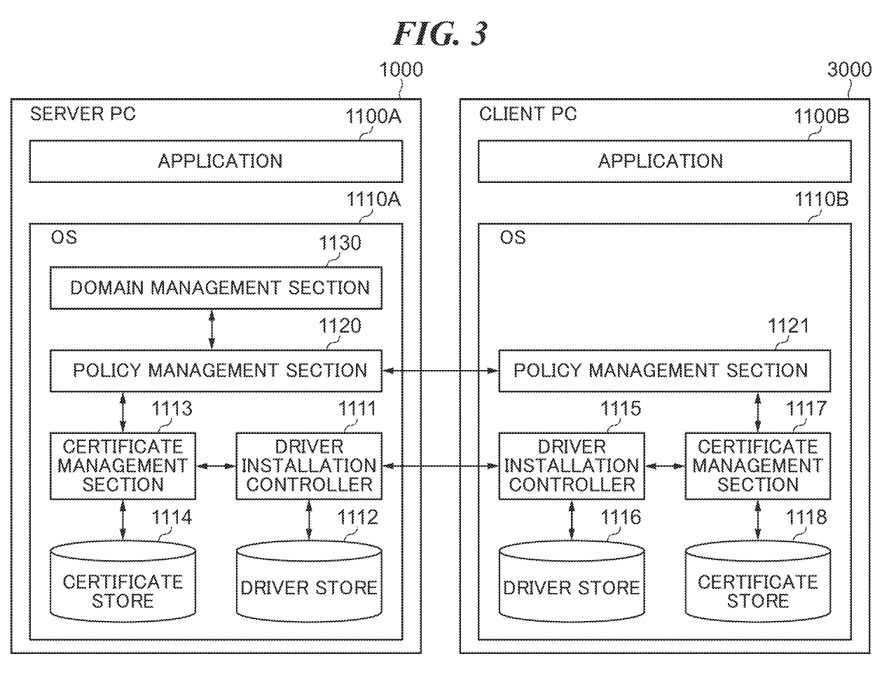

FIG. 3 is a block diagram showing software configurations of the server PC 1000 and the client PC 3000. As shown in FIG. 3, the server PC 1000 has an application 1100A and the OS 1110A. These software items are stored in the storage section 1030 of the server PC 1000. The application 1100A is a document generation application or a spreadsheet application, for example. Note that an installer 1210, described hereinafter, is also included in the application 1100A. The OS 1110A is software that controls basic operations of the server PC 1000. The OS 1110A has a driver installation controller 1111, a driver store 1112, a certificate management section 1113, a certificate store 1114, a policy management section 1120, and a domain management section 1130. The driver installation controller 1111 performs control for installing a printer driver available outside the OS 1110A into the OS 1110A. Here, the printer driver is software for controlling the printer 2000 from the server PC 1000. In general, this printer driver is provided from a maker that manufactures the printer 2000 or a vendor that supplies the printer 2000. Further, to install a printer driver into the OS 1110A refers to an operation of adding a printer driver provided from the maker or vendor to the OS 1110A to thereby enable the server PC 1000 to use the printer 2000 under the control of the OS 1110A. The driver installation controller 1111 verifies a printer driver to be installed and stores the printer driver in the driver store 1112. In the driver store 1112, besides the printer driver, a variety of drivers for controlling peripheral devices are also stored. The certificate management section 1113 manages certificates (certificate data) registered in the OS 1110A. The certificate store 1114 stores a variety of certificates managed by the certificate management section 1113 and used by the OS 1110A. Here, the certificate refers to data that certifies validity of a digital signature. A public key is included in the certificate. By using the public key, it is possible to extract a hash value from a digital signature and certify that a printer driver (file), having the digital signature attached thereto, has not been tampered. Information of the certificate is not particularly limited, but, for example, it can include an issuer of the certificate, version information of the certificate, a serial number of the certificate, the public key, and an expiration date of the certificate.

The policy management section 1120 manages operation settings (hereinafter referred to as the policy) of an information processing apparatus, such as the server PC 1000 and the client PC 3000, belonging to a predetermined domain. Examples of the policy which can be set include an operation which can automatically distribute a certificate to information processing apparatuses belonging to (participating in) the predetermined domain. In a case where the policy is set, the policy management section 1120 can register a certificate designated via the certificate management section 1113 in the certificate store 1114. The domain management section 1130 manages a domain to which information processing apparatuses belong. In the present embodiment, the server PC 1000 and the client PC 3000 belong to the same domain, and this domain is managed by the domain management section 1130. Further, according to a policy set to the policy management section 1120, the domain management section 1130 can apply this policy to the information processing apparatuses belonging to the domain. Although the domain management section 1130 is included in the configuration of the server PC 1000 in the present embodiment, this is not limitative, but, for example, the domain management section 1130 can be included in the configuration of another information processing apparatus, such as the client PC 3000.

In a case where the printer 2000 is used by the client PC 3000, a printer driver which has been installed in the server PC 1000 is installed in the client PC 3000 by using the mechanism of Point & Print In Point & Print, a printer made public on the server PC 1000 is designated from the client PC 3000, whereby the printer driver on the server PC 1000 is transferred to the client PC 3000. This printer driver is processed similarly to the above-described driver installation processing on the server PC 1000. This makes it also possible to use the printer 2000 on the client PC 3000 as well.

As shown in FIG. 3, the client PC 3000 has an application 1100B and an OS 1110B. These software items are stored in the storage section 1030 of the client PC 3000. Similar to the application 1100A, the application 1100B is a document generation application or a spreadsheet application, for example. The OS 1110B is software that controls the basic operation of the client PC 3000. The OS 1110B has a driver installation controller 1115, a driver store 1116, a certificate management section 1117, a certificate store 1118, and a policy management section 1121. The driver installation controller 1115 performs control for installing the printer driver transferred from the server PC 1000 into the OS 1110B. Further, the driver installation controller 1115 verifies this printer driver to be installed and stores the printer driver in the driver store 1116. The certificate management section 1117 stores a certificate attached to the printer driver verified by the driver installation controller 1115 in the certificate store 1118. Further, in a case where a certificate has been registered in the policy management section 1120 of the server PC 1000, and at the same time a setting that this certificate can be automatically distributed has been made, the policy management section 1121 copies the certificate to the client PC 3000. Then, the certificate management section 1117 registers the certificate in the certificate store 1118.

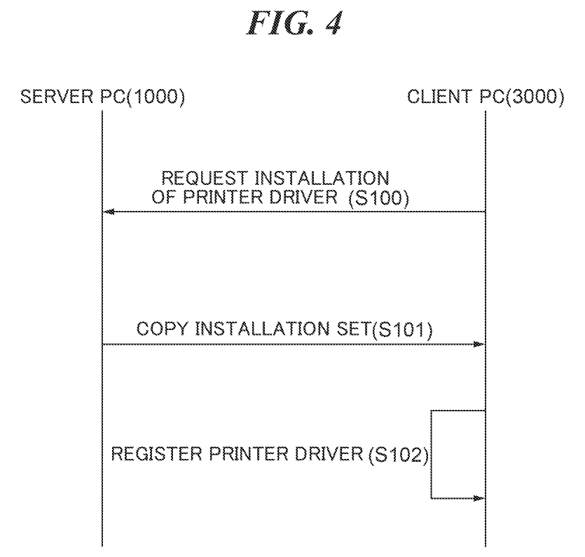

FIG. 4 is a sequence diagram showing a process (installation process) executed between the server PC 1000 and the client PC 3000. Referring to FIG. 4, in a step S100, the driver installation controller 1115 of the client PC 3000 connects to a shared printer (the printer 2000 in the present embodiment) shared with the server PC 1000. Then, the driver installation controller 1115 transmits a request for installing a printer driver that controls the printer 2000, to the server PC 1000. At this time, the server PC 1000 receives device information (including a type of the OS 1110B) concerning the client PC 3000, by Point & Prin. This makes it possible for the server PC 1000 to determine the operation environment of the client PC 3000.

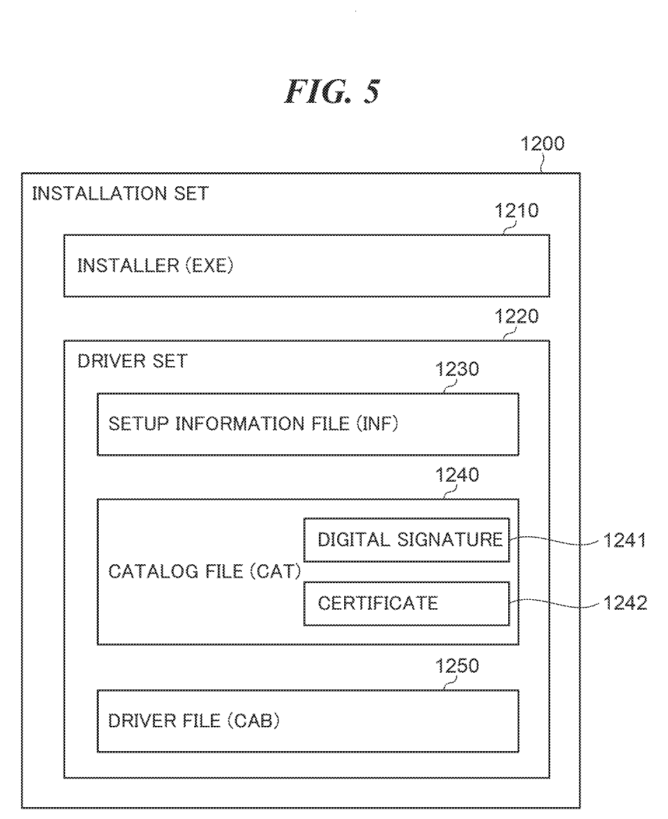

In a step S101, the driver installation controller 1111 of the server PC 1000 copies an installation set 1200 (see FIG. 5) of the printer driver, which is stored in the storage section 1030 of the server PC 1000, to the client PC 3000. This copy processing is executed by the driver installation controller 1111 in cooperation with the driver installation controller 1115 of the client PC 3000.

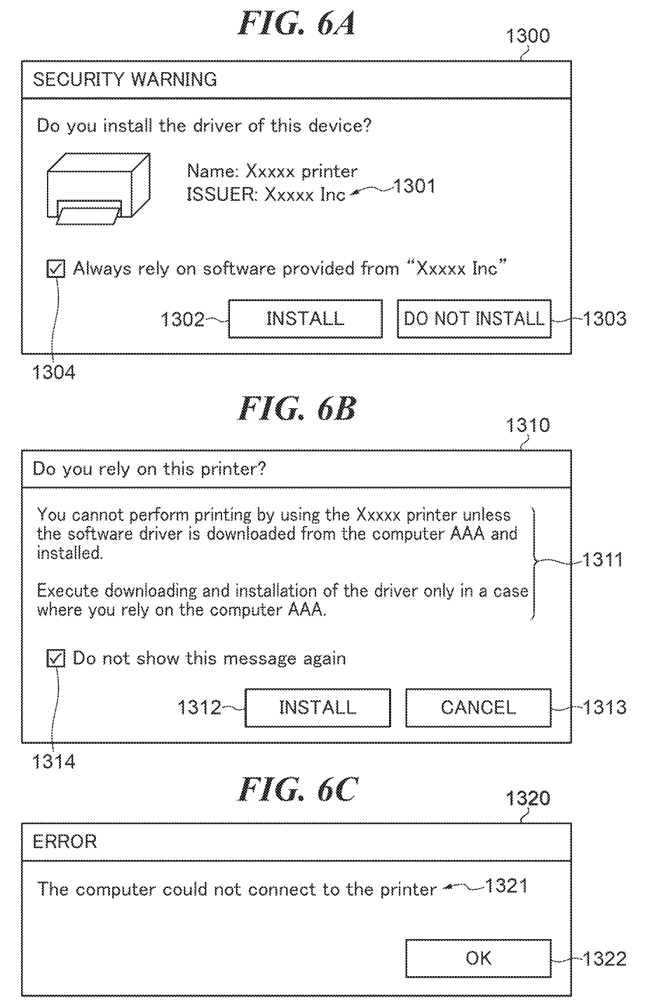

In a step S102, the driver installation controller 1115 of the client PC 3000 registers the printer driver copied in the step S101 in the OS 1110B. At this time, in a case where the certificate of the printer driver to be installed does not exist in the certificate store 1118, the OS 1110B of the client PC 3000 displays a screen (see FIG. 6B) to the user, so as to confirm whether or not to permit installation of the printer driver. Then, in a case where installation of the printer driver is completed, the user can cause the printer 2000 to execute printing via the server PC 1000 by operating the client PC 3000.

FIG. 5 is a diagram showing a configuration of the installation set 1200 of the printer driver. The installation set 1200, shown in FIG. 5, is provided from the maker or the vendor. The installation set 1200 is a file group including the installer (EXE) 1210 and a driver set 1220. The installer 1210 is a program for installing the printer driver and can cause the controller 1040 of the server PC 1000 to execute steps (control method), described hereinafter. The driver set 1220 includes a setup information file (INF) 1230, a catalog file (CAT) 1240, and a driver file (CAB) 1250. The catalog file 1240 includes a digital signature 1241 and a certificate (certificate data) 1242. The digital signature 1241 includes the certificate 1242. Note that although in the hierarchical configuration shown in FIG. 5, the digital signature 1241 and the certificate 1242 are parallel in hierarchy, this is not limitative. For example, the certificate 1242 can be included in the digital signature 1241.

A user having the authority of the administrator is allowed to perform an operation of installing the driver file 1250. The driver file 1250 is a file generated by compressing the printer driver for controlling the printer 2000, a data file, and so forth. The setup information file 1230 includes information necessary for installing the driver file 1250. This information is not particularly limited, but includes, for example, a type of the printer driver, a version of the printer driver, a file name of the catalog file 1240, a file name of the driver file 1250, and an installation destination of the driver file 1250. The catalog file 1240 is used to verify the driver set 1220 before installing the driver file 1250. The catalog file 1240 is used for determination of whether or not the driver file 1250 has been tampered.

FIGS. 6A to 6C are diagrams each showing a screen displayed in the printing system. A security warning screen 1300 shown in FIG. 6A is displayed on the display section 1010 of the server PC 1000. This display is performed by the OS 1110A of the server PC 1000. In a case where an application programming interface (API) for driver installation is called, the OS 1110A acquires the file name of the catalog file 1240 included in the setup information file 1230. Then, the OS 1110A refers to this catalog file 1240 and identifies the certificate 1242 associated with the digital signature 1241 included in the catalog file 1240. The OS 1110A displays the security warning screen 1300 in a case where this certificate 1242 does not exist in the certificate store 1114 of the OS 1110A. The security warning screen 1300 includes issuer information 1301, a button 1302, a button 1303, and a checkbox 1304. The issuer information 1301 is information related to an issuer of the digital signature 1241 and can be e.g. a maker name or a vendor name. By pressing (operating) the button 1302, the OS 1110A starts installation of the printer driver to which the digital signature 1241 of the issuer has been attached. On the other hand, by pressing the button 1303, the OS 1110A cancels installation of the printer driver. Thus, the security warning screen 1300 can prompt a user to determine whether or not to install the printer driver. The checkbox 1304 enables the user to select whether or not a user always relies on the printer driver to which the certificate 1242 of the same issuer as the digital signature 1241 has been attached. In a case where the button 1302 is pressed in an ON state in which the checkbox 1304 is checked, the OS 1110A stores (installs) the corresponding certificate 1242 in the certificate store 1114. Then, thereafter, in a case where a printer driver is to be installed to which the same certificate 1242 as the certificate 1242 stored in the certificate store 1114 has been attached, the display of the security warning screen 1300 is inhibited. On the other hand, in a case where the button 1302 is pressed in an OFF state in which the checkbox 1304 is not checked, the OS 1110A displays the security warning screen 1300 again before installing the printer driver to which the same certificate 1242 has been attached. By displaying the security warning screen 1300 again, it is possible to prevent installation of a printer driver signed e.g. by a suspicious issuer. Note that in the present embodiment, installation of the printer driver is executed when the button 1302 is pressed in the ON state in which the checkbox 1304 is checked.

A security warning screen 1310 shown in FIG. 6B is displayed on the display section 1010 of the client PC 3000. The security warning screen 1310 is displayed in a case where a printer driver is installed from the server PC 1000 into the client PC 3000. This display is performed by the OS 1110B of the client PC 3000. In a case where an API for driver installation is called, the OS 1110B acquires the file name of the catalog file 1240 included in the setup information file 1230 downloaded from the server PC 1000. Then, the OS 1110B refers to this catalog file 1240 and identifies the certificate 1242 associated with the digital signature 1241 included in the catalog file 1240. The OS 1110B displays the security warning screen 1310 in a case where this certificate 1242 does not exist in the certificate store 1118 of the OS 1110B. The security warning screen 1310 includes a message 1311, a button 1312, a button 1313, and a checkbox 1314. The message 1311 is a message concerning e.g. a use condition of a shared printer and reliability of the server PC 1000 (computer AAA). By pressing the button 1312, the OS 1110B starts installation of the printer driver. On the other hand, by pressing the button 1313, the OS 1110B cancels installation of the printer driver. Thus, similar to the security warning screen 1300, the security warning screen 1310 enables a user to determine whether or not to install the printer driver. The checkbox 1314 enables the user to select whether or not to display the message 1311 thereafter. In a case where the button 1312 is pressed in an ON state in which the checkbox 1314 is checked, the OS 1110B stores the certificate 1242 in question in the certificate store 1118. Then, thereafter, in a case where a printer driver is to be installed to which the same certificate 1242 as the certificate 1242 stored in the certificate store 1118 has been attached, the display of the security warning screen 1310 is inhibited. On the other hand, in a case where the button 1312 is pressed in an OFF state in which the checkbox 1314 is not checked, the OS 1110B displays the security warning screen 1310 again before installing the printer driver to which the same certificate 1242 has been attached. By displaying the security warning screen 1310 again, it is possible to prevent installation of a printer driver signed e.g. by a suspicious issuer.

A security error screen 1320 shown in FIG. 6C is displayed on the display section 1010 of the client PC 3000. The security error screen 1320 is displayed in a case where a printer driver is installed from the server PC 1000 into the client PC 3000. This display is performed by the OS 1110B of the client PC 3000. Similar to the case where the security warning screen 1310 is displayed, the OS 1110B displays the security error screen 1320 in a case where the certificate 1242 does not exist in the certificate store 1118 of the OS 1110B. The security error screen 1320 includes a message 1321 and a button 1322. The message 1321 is a message that it was impossible to connect to the shared printer. When the button 1322 is pressed, the security error screen 1320 transitions to another screen.

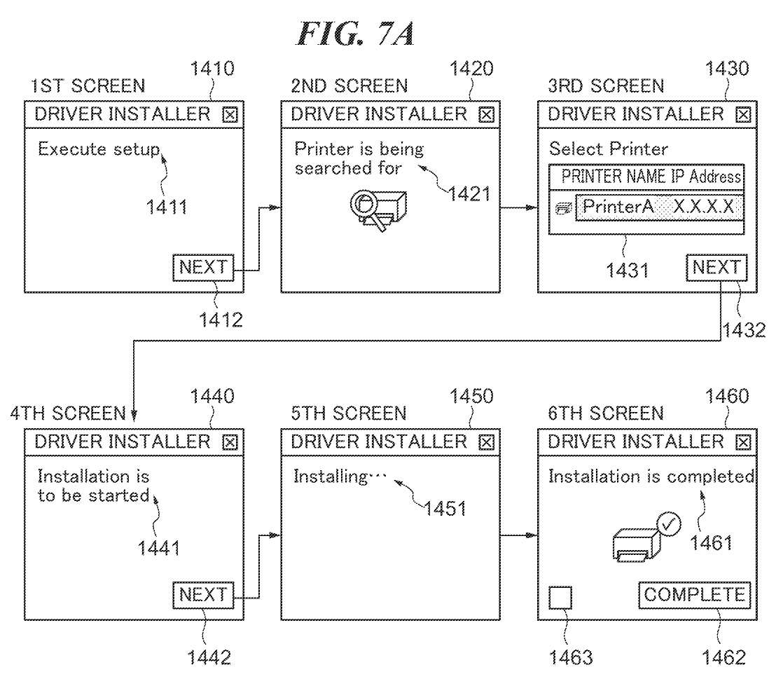

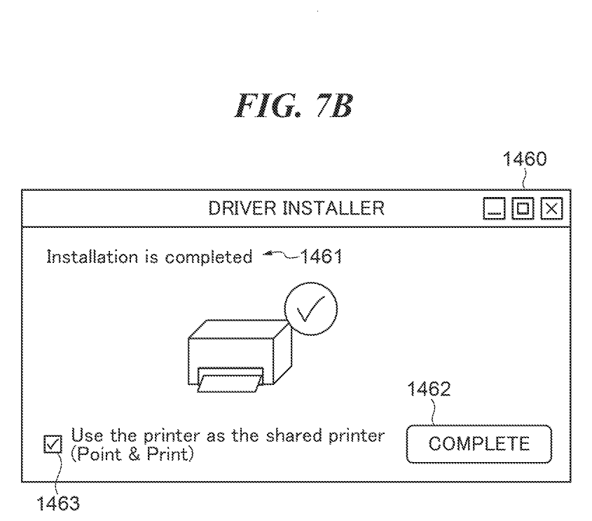

FIGS. 7A and 7B are diagrams useful in explaining transition of screens displayed on the display section of the server PC. Each screen shown in FIGS. 7A and 7B is displayed by the installer 1210 of the install set 1200, i.e. displayed when the installer 1210 of the install set 1200 is executed. Further, here, a case where the installer 1210 is executed in a state in which the certificate 1242 has not been stored in the certificate store 1114 will be described. Referring to FIG. 7A, on the display section 1010 of the server PC 1000, a first screen 1410, a second screen 1420, a third screen 1430, a fourth screen 1440, a fifth screen 1450, and a sixth screen 1460 are sequentially displayed. The first screen 1410 is displayed when the installer 1210 is started. The first screen 1410 includes a message 1411 and a button 1412. The message 1411 is a message for prompting a user to install the printer driver. By pressing the button 1412, the second screen 1420 is displayed.

The second screen 1420 includes a message 1421. The message 1421 is a message to the effect that a printer connected to the server PC 1000 and controlled by the printer driver to be installed is being searched for. In a case where the printer is detected, the third screen 1430 is displayed. The third screen 1430 includes a list 1431 and a button 1432. On the list 1431, a name and an IP address of the printer obtained by printer detection are displayed in a list. The third screen 1430 in FIG. 7A is in a state where a printer having a name of “Printer A” and an IP address of “X.X.X.X” is displayed, and this printer is selected, by way of example. Note that it is assumed that this printer is the printer 2000. In this case, the printer driver to be installed is a printer driver that controls the printer 2000. Then, by pressing the button 1432 in a state in which the printer 2000 is selected, the fourth screen 1440 is displayed.

The fourth screen 1440 includes a message 1441 and a button 1442. The message 1441 is a message to the effect that installation of the printer driver that controls the printer 2000 is to be started. By pressing the button 1442, the fifth screen 1450 is displayed. The fifth screen 1450 includes a message 1451. The message 1451 is a message to the effect that installation of the printer driver is being executed. Installation of the printer driver is executed by the installer 1210 calling the API for driver installation, which is provided by the driver installation controller 1111 of the OS 1110A. At this time, the installer 1210 designates the setup information file 1230 in the driver set 1220. As described above, the certificate 1242 has not been stored in the certificate store 1114. Therefore, the security warning screen 1300 is displayed. The display timing of the security warning screen 1300 can be set to a timing before the fourth screen 1440, i.e. between the third screen 1430 and the fourth screen 1440, or a timing after the fourth screen 1440, i.e. between the fourth screen 1440 and the fifth screen 1450. Then, in a case where installation of the printer driver is completed, the sixth screen 1460 is displayed.

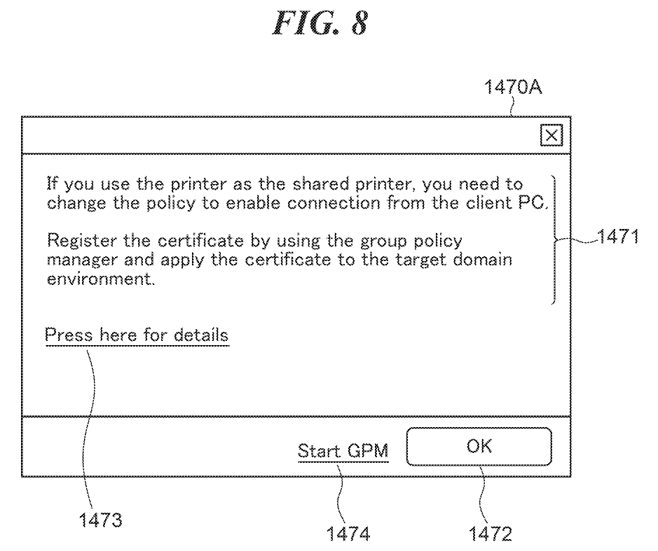

FIG. 7B is an enlarged detailed diagram of the sixth screen 1460. The sixth screen 1460 is a screen displayed before the determination in a sharing determination step, described hereinafter. This sixth screen 1460 is a selection screen on which whether or not to share the printer selected from the list 1431 on the third screen 1430 can be selected. The sixth screen 1460 includes a message 1461, a button 1462, and a checkbox 1463. The message 1461 is a message to the effect that installation is completed. The checkbox 1463 allows the user to select whether or not to use the printer selected from the list 1431 on the third screen 1430 as a shared printer. In a case where the button 1462 is pressed in an ON state in which the checkbox 1463 is checked, a seventh screen 1470A shown in FIG. 8 is displayed. On the other hand, in a case where the button 1462 is pressed in an OFF state in which the checkbox 1463 is not checked, the process performed by the installer 1210 is terminated without displaying the seventh screen 1470A.

FIG. 8 is a diagram showing the screen displayed on the display section 1010 of the server PC 1000. The seventh screen 1470A shown in FIG. 8 is a notification screen which is displayed when a shared printer is used and notifies a user of necessity of changing the settings of the policy to use the shared printer. For example, in Windows, it is possible to change the settings of the policy via an application, such as a group policy manager (GPM) that manages a group policy. The seventh screen 1470A includes a message 1471, a button 1472, a button 1473, and a button 1474. The message 1471 includes requirements for using the shared printer. As the requirements, there is described e.g. information to the effect that it is necessary to change the settings of the policy to use the shared printer, and to change the setting, it is necessary to install (register) the certificate 1242 into the client PC 3000 by using the group policy manager. By pressing the button 1472, the seventh screen 1470A shifts to another screen. By pressing the button 1473, it is possible to display a web page explaining a setting method of automatically applying a certificate to a computer participating in the domain by using the group policy manager. Note that in place of the button 1473, the description of this setting method can be included in the seventh screen 1470 or a screen different from the seventh screen 1470. By pressing the button 1474, it is possible to start the group policy manager. Note that the method of changing the settings of the policy is not limited to the method using the group policy manager, but any other suitable method can be used.

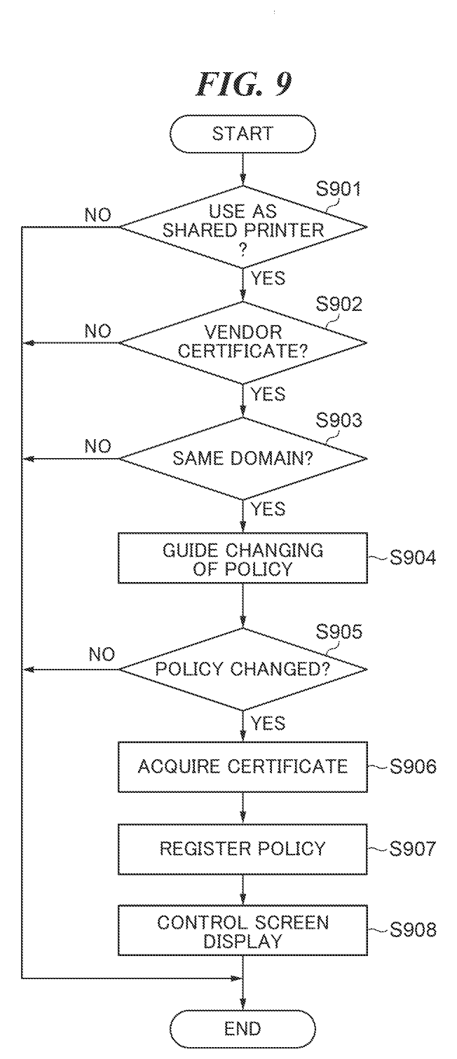

FIG. 9 is a flowchart of a process performed by the installer 1210. As shown in FIG. 9, in a step S901, the CPU 1041 (installer 1210) of the server PC 1000 determines whether or not to use a desired printer as the shared printer. This determination is also for determining whether or not the printer driver already installed in the server PC 1000 is set to be sharable between the server PC 1000 and the client PC 3000. Further, the determination is performed based on a selection state on the sixth screen 1460, i.e. whether or not the checkbox 1463 is checked. If the checkbox 1463 is checked, it is determined that the printer is to be used as the shared printer, and the process proceeds to a step S902. On the other hand, if the checkbox 1463 is not checked, it is determined that the printer is not to be used as the shared printer, and the process is terminated. In this case, execution of the step S902 et seq. is omitted.

In the step S902, the CPU 1041 determines whether or not the certificate 1242 is a vendor certificate (certificate) supplied from a supply source that supplies the printer driver to the server PC 1000. This determination is performed based on the issuer information included in the certificate 1242. For example, in a case where the true supply source is Xxxx Inc (see the issuer information 1301), if the issuer information included in the certificate 1242 is Xxxx Inc, it is determined that the certificate 1242 is the vendor certificate, the process proceeds to a step S903. On the other hand, if the issuer information included in the certificate 1242 is not Xxxx Inc, it is determined that the certificate 1242 is not the vendor certificate, the process is terminated. In this case, execution of the step S904 et seq. is also omitted.

In the step S903, the CPU 1041 determines whether or not the server PC 1000 belongs to the same domain as the client PC 3000 (domain determination step). This determination is performed based on the API. With this, it is possible to quickly and accurately perform the determination in the step S903. Then, if it is determined in the step S903 that the server PC 1000 belongs to the same domain as the client PC 3000, the process proceeds to the step S904. On the other hand, if it is determined in the step S903 that the server PC 1000 does not belong to the same domain as the client PC 3000, the process is terminated. In this case, execution of the step S904 et seq. is also omitted.

In the step S904, the CPU 1041 displays the seventh screen 1470A (see FIG. 8) which guides changing the settings of the policy on the display section 1010.

In a step S905, the CPU 1041 determines whether or not the settings of the policy have been changed. For example, this determination is performed as described below:

The user presses the button 1473 on the seventh screen 1470A. With this, as described above, by using the group policy manager, the web page explaining the setting method of automatically applying a certificate to a computer participating in the domain is displayed on the display section 1010. The user can perform a setting operation for automatically applying the certificate according to this web page. The determination in the step S905 is performed based on whether or not this setting operation has been performed. That is, in a case where the setting operation has been performed, it is determined that the settings of the policy have been changed, so that the process proceeds to a step S906, whereas in a case where the setting operation has not been performed, it is determined that the settings of the policy have not been changed, so that the process is terminated.

In the step S906, the CPU 1041 acquires the certificate 1242 from the catalog file 1240. By transmitting data (the driver set 1220) including the certificate 1242, the certificate 1242 is to be transmitted to the client PC 3000.

In a step S907, the CPU 1041 changes the settings of the policy (policy registration) on which it is determined in the step S905 that the settings of the policy have been changed, thereby enabling distribution of the certificate 1242 to the client PC 3000.

In a step S908, the CPU 1041 inhibits the display of the security warning screen 1310 (see FIG. 6B) and the security error screen 1320 (see FIG. 6C). Particularly, the security warning screen 1310 is a notification concerning the reliability of the printer driver when installing the printer driver in the client PC 3000. In the present embodiment, the setting of whether or not to perform the notification can be changed according to whether or not the setting operation has been performed in the step S905. Note that the seventh screen 1470A also functions as a screen for prompting a user to change the setting of whether or not to perform the notification.

In the printing system 100 configured as described above, it is possible to install the printer driver already installed in the server PC 1000 in the client PC 3000. Further, it is possible to use the printer 2000 controlled by the printer driver, also on the client PC 3000, as the shared printer. Further, before installing the printer driver into the client PC 3000, that is, before using the shared printer by the client PC 3000, the certificate 1242 is stored in the certificate store 1118. With this, the security warning screen 1310 and the security error screen 1320 are inhibited from being displayed. With this screen display inhibition, the user can quickly install the printer driver in the client PC 3000 without hesitation. Further, compared with a configuration not using Point & Print, the configuration using Point & Print can reduce the troublesome operation of, for example, additionally making a monitoring application ready for use for monitoring print data. Further, since the monitoring application and the like can be omitted, the printing system 100 can have a simple configuration.

Further, the step S902 can be omitted. In this case, the process proceeds to the step S903 regardless of whether or not the certificate 1242 is a vendor certificate. Further, the steps S904 and S905 can be omitted. In this case, if it is determined in the step S903 that the server PC 1000 belongs to the same domain, the settings of the policy are forcibly changed. Further, the seventh screen 1470A can also be displayed in the step S904 when using e.g. a function of adding a printer or adding a device, which is the driver installation function of the OS 1110A.

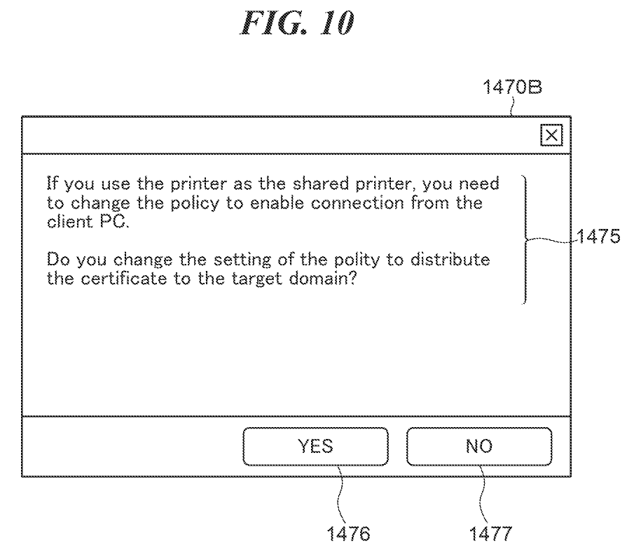

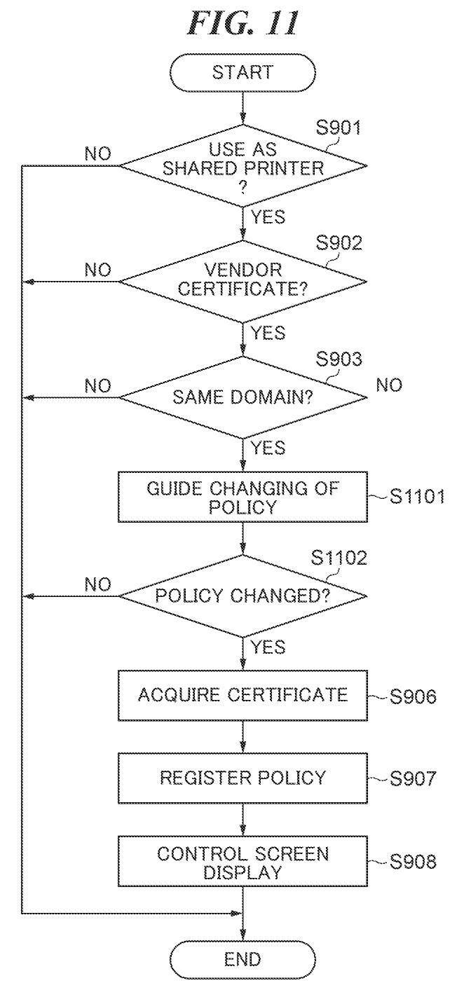

A second embodiment will be described below with reference to FIGS. 10 and 11, but the description will be given mainly of different points from the above-described embodiment, and description of the same points is omitted. FIG. 10 is a diagram showing a screen displayed on the display section of the server PC, according to the second embodiment. Similar to the seventh screen 1470A (see FIG. 8), a seventh screen 1470B shown in FIG. 10 is a notification screen displayed when a shared printer is used to notify a user that it is necessary to change the settings of the policy to use the shared printer, and the like. The seventh screen 1470B includes a message 1475, a button 1476, and a button 1477. The message 1475 includes the necessity of changing the policy when using the shared printer and an inquiry about whether or not to change the settings of the policy. When the button 1476 is pressed, it is determined that the user agrees to the contents of the message 1475, so that the processing according to the contents is executed to shift the seventh screen 1470B to another screen. When the button 1477 is pressed, the seventh screen 1470B shifts to another screen without agreement to the contents of the message 1475. Thus, the seventh screen 1470B includes an instruction operation section on which the operation of instructing whether or not to change the settings of the policy is performed. With this, the user can reduce the troublesomeness of operation performed by himself/herself for changing the settings of the policy.

FIG. 11 is a flowchart of a process performed by the installer 1210. The process in FIG. 11 is configured by adding a step S1101 and a step S1102 in place of the step S904 and the step S905 of the process in FIG. 9, respectively. Referring to FIG. 11, if it is determined in the step S903 that the server PC 1000 belongs to the same domain, the process proceeds to the step S1101. In the step S1101, the CPU 1041 of the server PC 1000 displays the seventh screen 1470B (see FIG. 10) on the display section 1010.

In the step S1102, the CPU 1041 determines whether or not the settings of the policy have been changed. This determination is performed based on an operation of pressing the button 1476 or the button 1477 on the seventh screen 1470B. In a case where the button 1476 has been pressed, it is determined that the settings of the policy have been changed, so that the process sequentially proceeds to the steps S906 to S908, whereas in a case where the button 1477 has been pressed, it is determined that the settings of the policy have not been changed, so that the process is terminated.

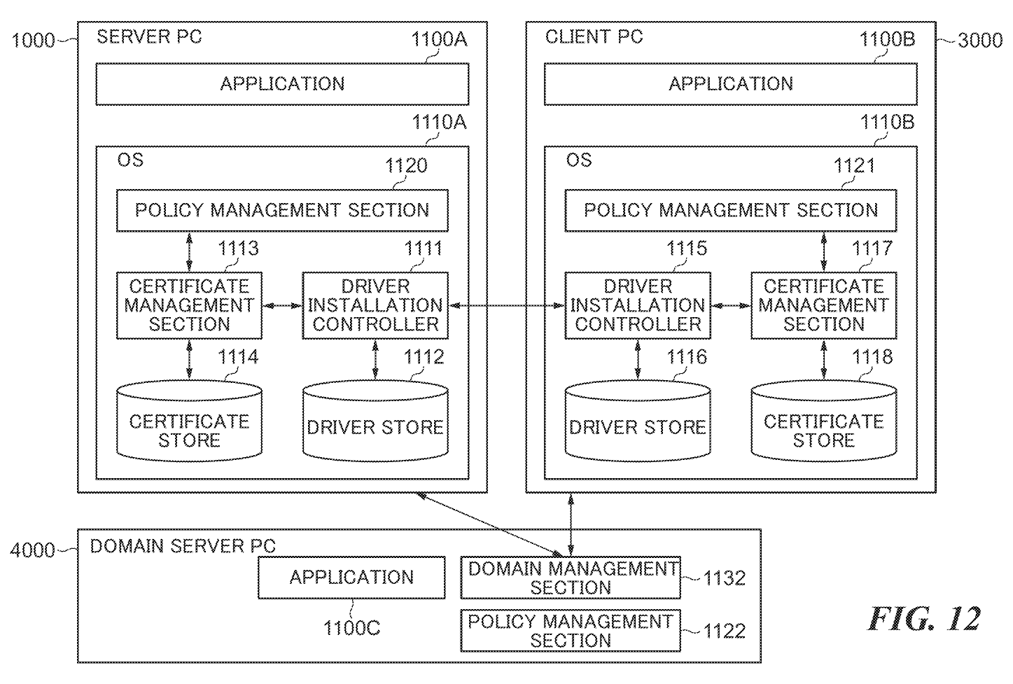

A third embodiment will be described below with reference to FIGS. 12 to 14, but the description will be given mainly of different points from the above-described embodiments, and description of the same points is omitted. FIG. 12 is a block diagram showing software configurations of the server PC 1000, the client PC 3000, and a domain server PC 4000, according to the third embodiment. As shown in FIG. 12, the server PC 1000, the client PC 3000, and the domain server PC 4000 are communicably connected to each other. Further, these apparatuses belong to the same domain. The domain server PC 4000 includes an application 1100C, a domain management section 1132, and a policy management section 1122. Similar to the application 1100A and the application 1100B, the application 1100C is e.g. a document generation application or a spreadsheet application. The domain management section 1132 applies a policy registered in cooperation with the policy management section 1122 to the server PC 1000 and the client PC 3000. Here, it is assumed that the policy includes a policy of distributing a certificate to be registered is set.

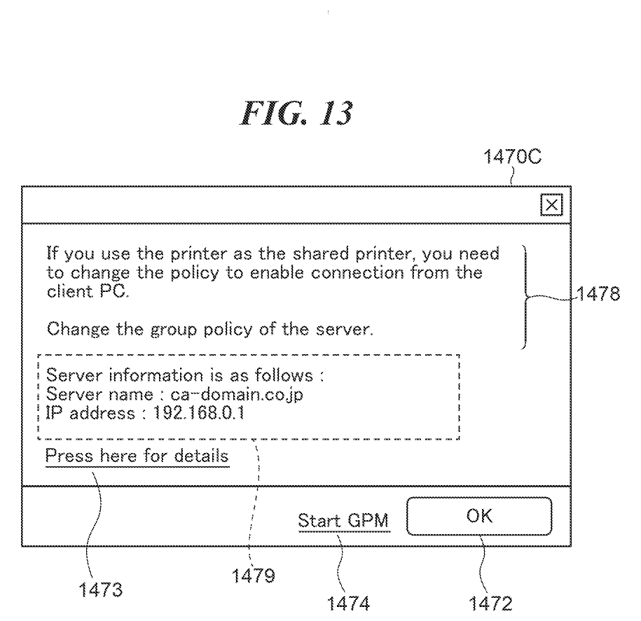

FIG. 13 is a diagram showing a screen displayed on the display section of the server PC 1000. Similar to the seventh screen 1470A (see FIG. 8) and the seventh screen 1470B (see FIG. 10), a seventh screen 1470C shown in FIG. 13 is a notification screen which is displayed when using a shared printer and notifies a user of necessity of changing the settings of the policy to use the shared printer, and the like. The seventh screen 1470C includes a message 1478, a display area 1479, the button 1472, the button 1473, and the button 1474. The message 1478 is a message including the necessity of changing the policy when using the shared printer and a guide for prompting a user to change the settings of the policy. The display area 1479 displays the name of the domain server PC 4000 and the IP address of the domain server PC 4000, which are acquired at the start time.

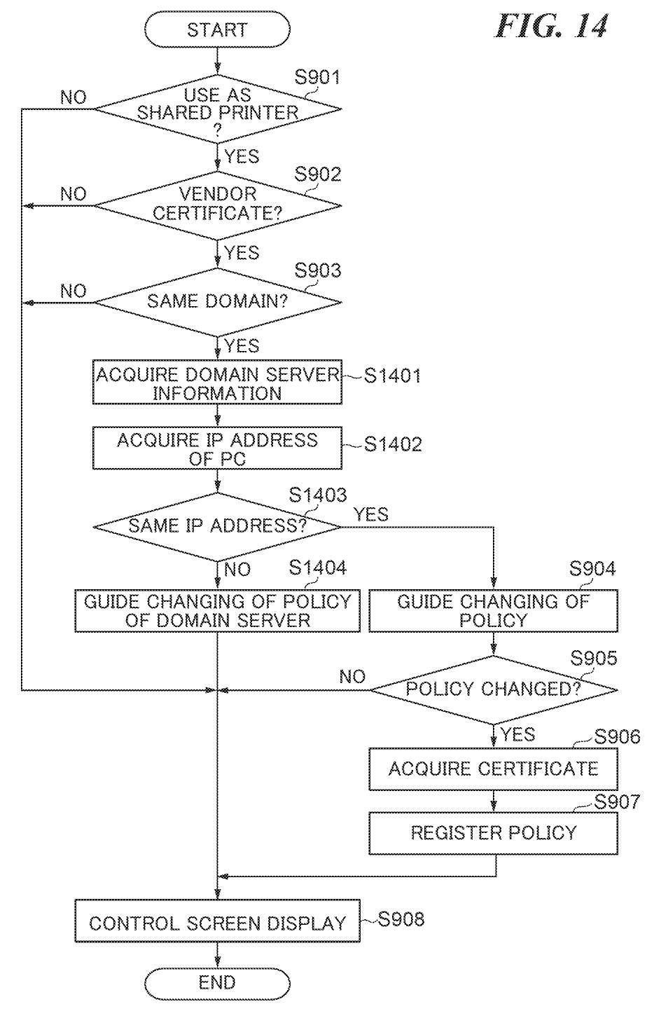

FIG. 14 is a flowchart of a process performed by the installer 1210. The process in FIG. 14 is the same as the process in FIG. 9 except that steps S1401 to S1404 are added. Referring to FIG. 14, if it is determined in the step S903 that the server PC 1000 belongs to the same domain, the process proceeds to the step S1401. In the step S1401, the CPU 1041 of the server PC 1000 acquires information concerning the domain server PC 4000 which manages a domain to which the server PC 1000 belongs. Note that it is assumed that this information includes the name of the domain server PC 4000 and the IP address of the domain server PC 4000.

In the step S1402, the CPU 1041 acquires the IP address of the server PC 1000.

In the step S1403, the CPU 1041 compares the IP address of the domain server PC 4000, which is included in the information acquired in the step S1401, and the IP address of the server PC 1000, which is acquired in the step S1402. Then, the CPU 1041 determines whether or not both of the IP addresses coincide with each other (are same). If it is determined in the step S1403 that both of the IP addresses coincide with each other, the process sequentially proceeds to the steps S 904 to S908. On the other hand, if it is determined in the step S1403 that both of the IP addresses do not coincide with each other, the process proceeds to the step S1404.

In the step S1404, the CPU 1041 displays the seventh screen 1470C (see FIG. 13) on the display section 1010. With this, the user can change the policy to register the certificate 1242 in the domain server PC 4000 according to the message 1478 on the seventh screen 1470C.

According to the present disclosure, it is possible to quickly install a printer driver.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-185922, filed October 22, 2024, which is hereby incorporated by reference herein in its entirety.

What is claimed is:

1. A non-transitory computer-readable storage medium storing a program for installing a printer driver having already been installed in a first information processing apparatus and having certificate data attached thereto for certifying validity of a digital signature, into a second information processing apparatus communicably connected to the first information processing apparatus,
wherein the program causes a computer of the first information processing apparatus to execute:
a sharing determination step for determining whether or not the printer driver having already been installed is set to be sharable with the second information processing apparatus; and
a display step for displaying, in a case where it is determined in the sharing determination step that the printer driver is set to be sharable with the second information processing apparatus, a screen related to changing of setting of whether or not to perform notification concerning reliability of the printer driver when installing the printer driver into the second information processing apparatus.

2. The storage medium according to claim 1, wherein the program causes the computer to execute a domain determination step for determining whether or not the first information processing apparatus belongs to the same domain as the second information processing apparatus, and
wherein in the display step, in a case where it is determined in the sharing determination step that the printer driver is set to be sharable with the second information processing apparatus, and at the same time it is determined in the domain determination step that the first information processing apparatus belongs to the same domain as the second information processing apparatus, the screen related to changing of the setting of whether or not to perform the notification is displayed.

3. The storage medium according to claim 2, wherein in a case where it is determined in the domain determination step that the first information processing apparatus does not belong to the same domain as the second information processing apparatus, the screen is not displayed in the display step.

4. The storage medium according to claim 2, wherein the determination in the domain determination step is performed based on an application programming interface (API).

5. The storage medium according to claim 1, wherein in a case where it is determined in the sharing determination step that the printer driver is not set to be sharable with the second information processing apparatus, the screen is not displayed in the display step.

6. The storage medium according to claim 1, wherein before the determination in the sharing determination step, a selection screen for selecting whether or not to share the printer driver is displayed, and
wherein the determination in the sharing determination step is performed based on a selection state on the selection screen.

7. The storage medium according to claim 1, wherein the program causes the computer to execute a transmission step for transmitting the certificate data that certifies validity of the digital signature to the second information processing apparatus.

8. The storage medium according to claim 7, wherein the program causes the computer to execute a domain determination step for determining whether or not the first information processing apparatus belongs to the same domain as the second information processing apparatus, and
a data determination step for determining whether or not the certificate data is certificate data supplied from a supply source supplying the printer driver to the first information processing apparatus, between the sharing determination step and the domain determination step.

9. The storage medium according to claim 1, wherein in the display step, a screen for prompting a user to change the setting of whether or not to perform the notification can be displayed.

10. The storage medium according to claim 9, wherein the screen includes an instruction operation section on which the operation of instructing changing the setting of whether or not to perform the notification is performed.

11. A control method of performing control to install a printer driver having already been installed in a first information processing apparatus and having certificate data attached thereto for certifying validity of a digital signature, into a second information processing apparatus communicably connected to the first information processing apparatus, comprising:
determining whether or not the printer driver which has been installed is set to be sharable with the second information processing apparatus; and
displaying, in a case where it is determined that the printer driver is set to be sharable with the second information processing apparatus, a screen related to changing of setting of whether or not to perform notification concerning reliability of the printer driver when installing the printer driver into the second information processing apparatus.

12. An information processing apparatus in which a printer driver having certificate data certifying validity of a digital signature attached thereto has been installed, comprising:
a program for installing, in a case where the information processing apparatus is set as a first information processing apparatus, the printer driver into a second information processing apparatus communicably connected to the first information processing apparatus,
the program causing a computer of the first information processing apparatus to execute:
a sharing determination step for determining whether or not the printer driver which has been installed is set to be sharable with the second information processing apparatus; and
a display step for displaying, in a case where it is determined in the sharing determination step that the printer driver is set to be sharable with the second information processing apparatus, a screen related to changing of setting of whether or not to perform notification concerning reliability of the printer driver when installing the printer driver into the second information processing apparatus.
